(19) United States
(12) Patent Application Publication
(10) Pub. No.: US 2025/0346982 A1
(43) Pub. Date: Nov. 13, 2025

(54) ROLL FORMED STEEL COMPONENT

(71) Applicant: GM Global Technology Operations LLC, Detroit, MI (US)

(72) Inventors: Zhou Wang, Shanghai (CN); MingFeng Shi, West Bloomfield, MI (US); Sarah Tedesco, Novi, MI (US); Jianfeng Wang, Shanghai (CN); Zhen Chen, Shanghai (CN); Jiachen Pang, Shanghai (CN)

(21) Appl. No.: 18/663,399

(22) Filed: May 14, 2024

(30) Foreign Application Priority Data
May 10, 2024 (CN) 202410578334.0

(51) Int. Cl. C22C 38/38; C21D 1/18; C21D 1/44; C21D 6/00; C22C 38/02

(52) U.S. Cl. CPC C22C 38/38; C21D 1/18; C21D 1/44; C21D 6/002; C22C 38/02; C21D 2211/001; C21D 2211/002; C21D 2211/005; C21D 2211/008

(57) ABSTRACT

A close section roll-formed component using coating free press-hardened steel is provided. The close section roll-formed component using coating free press-hardened steel includes the component having a microstructure including martensite and alloy carbide, a weld seam that joins at least two edges of the component, and at least one corner of the component. The component has a composition between 0.05 and 0.35 wt. % carbon, between 0.5 and 5.0 wt. % manganese, between 0.5 and 2.0 wt. % silicon, and 0.6 and 4.0 wt. % chromium. The at least one corner has a corner radius between 0.5t and 2t (t is wall thickness). The wall thickness of the component is between 0.8 millimeters and 5.0 millimeters. Additionally, the component has an ultimate tensile strength between 1.5 gigapascals (GPa) and 2.1 GPa and a hardness across the weld seam between Vickers Pyramid Number (HV) 450 and 600.

### CROSS-REFERENCE TO RELATED APPLICATIONS

This application claims the benefit of foreign priority under 35 U.S.C. § 119 of Chinese patent application number 2024105109108, filed on Apr. 25, 2024. The contents of this application are incorporated herein by reference in their entirety.

### INTRODUCTION

The present disclosure relates to coating free press-hardened steel used in vehicle structural and body members, and, more particularly, to roll-formed components with a close section.

Press hardened steel is used in vehicles including automobiles, trucks, vans, sport utility vehicles, autonomous vehicles, battery electric vehicles, farm or construction equipment, railway vehicles, and the like to provide regional or local increased material strength in load-bearing components and to mitigate against material collapse in impact zones of vehicle bodies, for example door beams and body pillars.

Current press hardened steel (PHS) is entirely formed in a furnace. A coating layer, such as aluminum-silicon, is applied to the steel prior to heating for barrier protection from corrosion and to prevent surface scale development and decarburization during the hot forming process. In the furnace, a heating rate and final heating temperature must be carefully controlled to avoid melting the coating, to control the interdiffusion layer thickness between substrate and coating, and to achieve the desired strength after hot forming.

Roll-formed steel components are widely used in rechargeable energy storage systems (RESS) structures in vehicles (e.g., >20 kilograms per vehicle). Steels with higher strength, for example martensitic steels, are used for lightweighting and cost saving. However, challenges exist for high strength roll-formed components when using martensitic steels. Some challenges include 1) poor coil flatness and large residual stress, which cause poor dimensional tolerance, especially for complex section components; 2) a large corner radius consuming RESS space; 3) poor laser weld quality for a close section due to the waviness of the weld edges and heat affected zone; and 4) a strength limitation of 1.7 gigapascal (GPa) and a limited global supply base of 1.5 GPa and 1.7 GPa MS grade high strength steel.

Thus, while current systems and methods to produce and utilize martensitic steel roll-formed close section components achieve their intended purpose, there is a need for a new and improved system and method to produce and use roll-formed close section components.

### SUMMARY

According to several aspects of the present disclosure, a close section roll-formed component using coating free press-hardened steel is provided. The close section roll-formed component using coating free press-hardened steel includes the component having a microstructure including martensite and alloy carbide, a weld seam that joins at least two edges of the component, and at least one corner of the component. The component has a composition between 0.05 and 0.35 wt. % carbon, between 0.5 and 5.0 wt. % manganese, between 0.5 and 2.0 wt. % silicon, and 0.6 and 4.0 wt. % chromium. The at least one corner has a corner radius between 0.5t and 2t (t is wall thickness). The wall thickness of the component is between 0.8 millimeters and 5.0 millimeters. Additionally, the component has an ultimate tensile strength between 1.5 gigapascals (GPa) and 2.1 GPa and a hardness across the weld seam between Vickers Pyramid Number (HV) 450 and 600.

In accordance with another aspect of the disclosure, the close section roll-formed component has a yield strength of between 1.0 gigapascals (GPa) and 1.8 GPa.

In accordance with another aspect of the disclosure, the close section roll-formed component has a hardness between Vickers Pyramid Number (HV) 450 and 600.

In accordance with another aspect of the disclosure, the close section roll-formed component has a surface oxidation between 0.1 micrometers (μm) and 5.0 μm.

In accordance with another aspect of the disclosure, the close section roll-formed component includes ferrite less than 5 vol. %.

In accordance with another aspect of the disclosure, the close section roll-formed component includes bainite and austenite less than 20 vol. %.

In accordance with another aspect of the disclosure, the close section roll-formed component includes a carbide fraction between 1.0 vol. % and 20 vol. % with a size between 10 nanometers (nm) and 500 nm.

In accordance with another aspect of the disclosure, the close section roll-formed component includes a chromium content of carbides between 5 wt. % and 60 wt. %.

In accordance with another aspect of the disclosure, the close section roll-formed component includes niobium less than 0.05 wt. %.

In accordance with another aspect of the disclosure, the close section roll-formed component includes yttrium less than 0.3 wt. %.

In accordance with another aspect of the disclosure, the close section roll-formed component includes cerium less than 0.3 wt. %.

In accordance with another aspect of the disclosure, the close section roll-formed component includes a corner radius that is 1t where t is wall thickness.

According to several aspects of the present disclosure, a vehicular structural component is provided. The vehicular structural component includes a close section roll-formed component having a microstructure including martensite and alloy carbide, a weld seam that joins at least two edges of the component, and at least one corner of the component. The component has a composition between 0.05 and 0.35 wt. % carbon, between 0.5 and 5.0 wt. % manganese, between 0.5 and 2.0 wt. % silicon, and 0.6 and 4.0 wt. % chromium. The at least one corner has a corner radius between 0.5t and 2t (t is wall thickness). The wall thickness of the component is between 0.8 millimeters and 5.0 millimeters. The component has an ultimate tensile strength between 1.5 gigapascals (GPa) and 2.1 GPa and a hardness across the weld seam between Vickers Pyramid Number (HV) 450 and 600. Additionally, the component has a yield strength of between 1.0 gigapascals (GPa) and 1.8 GPa, a hardness between Vickers Pyramid Number (HV) 450 and 600, and a surface oxidation between 0.1 micrometers (μm) and 5.0 μm.

According to several aspects of the present disclosure, a method of forming a close section roll-formed component using coating free press-hardened steel is provided. The method includes roll-forming as-annealed steel, in-line welding the steel to form a close section roll-formed component, heating the close section roll-formed component to a temperature between 850° C. and 980° C., soaking the close section roll-formed component for between 1 second and 1000 seconds, and die quenching the close section roll-formed component including rectification of the component to provide dimensional accuracy. The as-annealed steel has a microstructure including martensite, alloy carbide, between 0.05 and 0.35 wt. % carbon, between 0.5 and 5.0 wt. % manganese, between 0.5 and 2.0 wt. % silicon, and 0.6 and 4.0 wt. % chromium. A hardness across the weld is between 450 Vickers Pyramid Number (HV) and 600 HV after heat treatment. At least one corner of the component has a corner radius between 0.5t and 2t where t is wall thickness. The wall thickness of the component is between 0.8 millimeters and 5.0 millimeters.

In accordance with another aspect of the disclosure, the method includes a component having a yield strength of between 1.0 gigapascals (GPa) and 1.8 GPa.

In accordance with another aspect of the disclosure, the method includes a component that has a hardness between Vickers Pyramid Number (HV) 450 and 600.

In accordance with another aspect of the disclosure, the method includes a component having a surface oxidation between 0.1 micrometers (μm) and 5.0 μm.

In accordance with another aspect of the disclosure, the method includes a corner radius of 1t.

In accordance with another aspect of the disclosure, the method includes a component having ferrite less than 5 vol. %.

In accordance with another aspect of the disclosure, the method includes a component having bainite and austenite less than 20 vol. %.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view illustrating an example of a vehicle including a battery pack having a plurality of battery cells, in accordance with the present disclosure.

FIG. 2 is a perspective view of the battery pack disposed within the vehicle shown in FIG. 1, where the battery pack is a rechargeable energy storage system (RESS) having multiple close section roll-formed components, in accordance with an exemplary embodiment.

FIG. 3 is a perspective view of a close section roll-formed component shown in FIG. 2, in accordance with the present disclosure.

FIG. 4 is a partial cross section view of a corner of the close section roll-formed component shown in FIGS. 2 and 3, in accordance with the present disclosure.

FIG. 5 is a cross-section view of the close section roll-formed component shown in FIGS. 2 and 3, where the close section roll-formed component is in a tubular configuration with an inverted corner, in accordance with the present disclosure.

FIG. 6 is a cross-section view of the close section roll-formed component shown in FIGS. 2 and 3, where the close section roll-formed component includes two adjacent chambers, in accordance with the present disclosure.

FIG. 7 is a cross-section view of the close section roll-formed component shown in FIGS. 2 and 3, where the close section roll-formed component includes two chambers joined by a planar section, in accordance with the present disclosure.

FIG. 8 is a cross section view of the close section roll-formed component shown in FIGS. 2 and 3, where the close section roll-formed component includes three adjacent chambers, in accordance with the present disclosure.

FIG. 9 is a flow diagram of a method of forming the close section roll-formed component illustrated in FIGS. 2 through 8, in accordance with an exemplary embodiment.

### DETAILED DESCRIPTION

The following description is merely exemplary in nature and is not intended to limit the present disclosure, application, or uses.

When a component, element or layer is referred to as being “on”, “engaged to”, “connected to”, or “coupled to” another element or layer, it may be directly on, engaged, connected or coupled to the other component, element, or layer, or intervening elements or layers may be present. In contrast, when an element is referred to as being “directly on”, “directly engaged to”, “directly connected to”, or “directly coupled to” another element or layer, there may be in intervening elements or layers present. Other words used to describe the relationship between elements should be interpreted in a like fashion, such as “between” versus “directly between”, “adjacent” versus “directly adjacent”, and the like. As used herein, the term “and/or” includes any and all combinations of one or more of the associated listed items.

The close section roll-formed component and method disclosed herein provides an up to 2 GPa close section roll-formed component with a 1t (where t is steel thickness) corner radius with no heat affected zone at the weld seam, which is obtained by roll forming a coating-free steel in an as-annealed soft state into a close section tube and then heating and quenching the tube.

Referring to FIG. 1, a perspective view of a vehicle 10 having a battery pack 12 is illustrated, in accordance with the present disclosure. The battery pack 12 is illustrated with an exemplary vehicle 10. The vehicle 10 is an electric vehicle or hybrid vehicle having wheels 11 driven by electric motors/inverters 13. The electric motors/inverters 13 receive power from the battery pack 12. While the vehicle 10 is illustrated as a passenger road vehicle, it should be appreciated that the battery pack 12 may be used with various other types of vehicles. For example, the battery pack 12 may be used in nautical vehicles, such as boats, or aeronautical vehicles, such as drones or passenger airplanes. Moreover, the battery pack 12 may be used as a stationary power source separate and independent from a vehicle. Battery pack 12 includes a case 14 for supporting a plurality of battery cells 18. The battery pack 12 may have fifty or more battery cells 18.

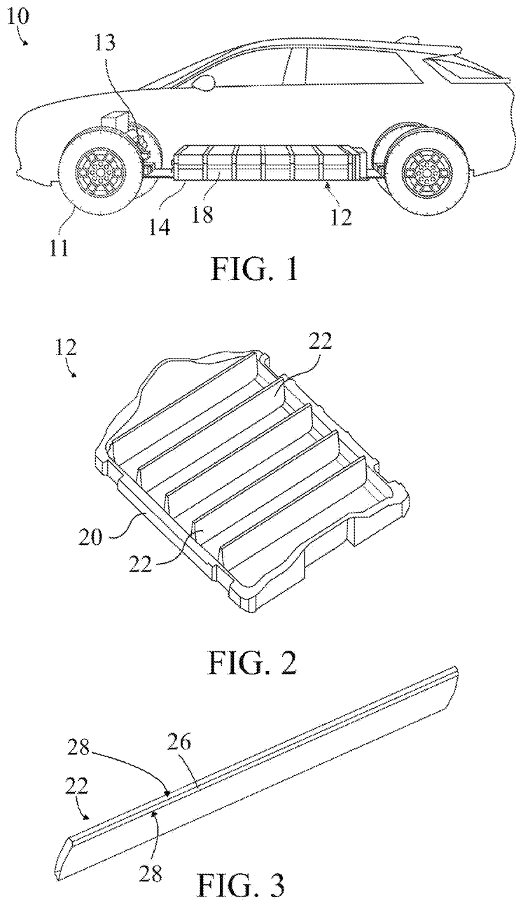

FIG. 2 illustrates a perspective view of the battery pack 12 shown in FIG. 1. The battery pack 12 generally includes a battery pan 20 supported by a battery tray (not shown) that is coupled to the vehicle 10. The battery pack 12 also generally includes a plurality of battery cells (not shown).

The battery pan 20 further includes at least one close section roll-formed component 22 (or “vehicular structural component”) that provides support to and/or within the battery pack 12. The close section roll-formed component 22 is formed of coating-free press-hardened steel (CFPHS). The close section roll-formed component 22 is usable in other structural components (e.g., door beams, A-pillars that connect a windshield to a roof of a car, and so forth) in vehicles.

The close section roll-formed component 22 includes a component formed from rolling involving continuous bending of a long section of sheet metal (e.g., coiled steel) into a desired cross section. The section of sheet metal passes through sets of rolls mounted on consecutive stands, each set performing an incremental part of the bend until a desired cross section profile is obtained. The close section roll-formed component 22 is in tubular form and may include a variety of cross section geometries, for example circular, concentric, square, and the like.

Coating-free press-hardened steel (CFPHS) is uncoated steel with a low carbon (C) content and additions of chromium and silicon, which form a thin oxide layer on a surface of the CFPHS after hot forming. CFPHS is an alternative to conventional aluminum silicon (Al—Si) coated press hardened steel, in which aluminum silicon (Al—Si) coating is applied to sheet steel before hot forming. Additionally, CFPHS is an uncoated PHS, in which an oxidation resistant layer would be developed during heating to protect the surface, thus eliminating a need for Al—Si coating or shot blasting, and in the case of traditional uncoated (bare) PHS, post processing to maintain surface quality

A material chemistry of the close section roll-formed component 22 includes carbon (C) at a concentration of greater than or equal to 0.05% to less than or equal to about 0.35 percent weight (wt. %), manganese (Mn) at a concentration of greater than or equal to about 0.5 wt. % to less than or equal to about 5.0 wt. %, silicon (Si) at a concentration of greater than or equal to about 0.5 wt. % to less than or equal to about 2.0 wt. %, chromium (Cr) at a concentration of greater than or equal to about 0.6 wt. % to less than or equal to about 4 wt. %, and a balance of iron (Fe). In some examples, the close section roll-formed component 22 may include other elements. For example, the close section roll-formed component 22 may include niobium less than 0.05 wt. %. Additionally, the close section roll-formed component 22 may include yttrium less than 0.3 wt. % and/or may include cerium less than 0.3 wt. %. In this context, the term “about” is known to those skilled in the art. Alternatively, the term “about” may be read to mean plus or minus 0.5% by weight.

The close section roll-formed component 22 has a microstructure including martensite and alloy carbide. Martensite includes a very hard form of steel crystalline structure. Martensite is formed when carbon steel is quenched of the austenite form at a high rate such that carbon atoms do not have time to diffuse out of the crystal structure. The face-centered austenite transforms to a highly strained body-centered tetragonal martensite that is highly saturated with carbon. In an example, the close section roll-formed component 22 includes a carbide fraction between 1.0% vol. and 20% vol. and a size between 10 nanometers (nm) and 500 nm.

The close section roll-formed component 22 is heated to transform the crystal structure of the steel from ferrite to austenite. Austenite is a more open and flexible structure that can absorb more carbon from iron-carbides in carbon steel. Transforming the ferrite to austenite, or austenitization, enables subsequent transformation to martensite upon cooling, which modifies the mechanical properties of the close section roll-formed component 22 so that it is suitable for use in, for example, vehicular structural components including a battery pack 12. Ferrite is generally an undesirable but unavoidable phase. In an example, the close section roll-formed component 22 includes less than 5 vol. % ferrite. Bainite is a plate-like microstructure that forms in steel at temperatures of 125-550° C. (depending on alloy content). Bainite is one product that may form when austenite is cooled past a temperature where the austenite is no longer thermodynamically stable with respect to ferrite. Bainite is generally an undesirable but unavoidable phase. In an example, the close section roll-formed component 22 includes less than 20 vol. % of a combination of bainite and austenite.

FIG. 3 illustrates the close section roll-formed component 22 shown in FIG. 3. The close section roll-formed component 22 is formed by continuous bending of a long section of sheet metal into a desired cross section. The section of sheet metal passes through sets of rollers. Each set of rollers performs an incremental part of the bend until a desired cross section profile is obtained. The close section roll-formed component 22 has a closed or enclosed profile and may be tubular, as illustrated in FIG. 3.

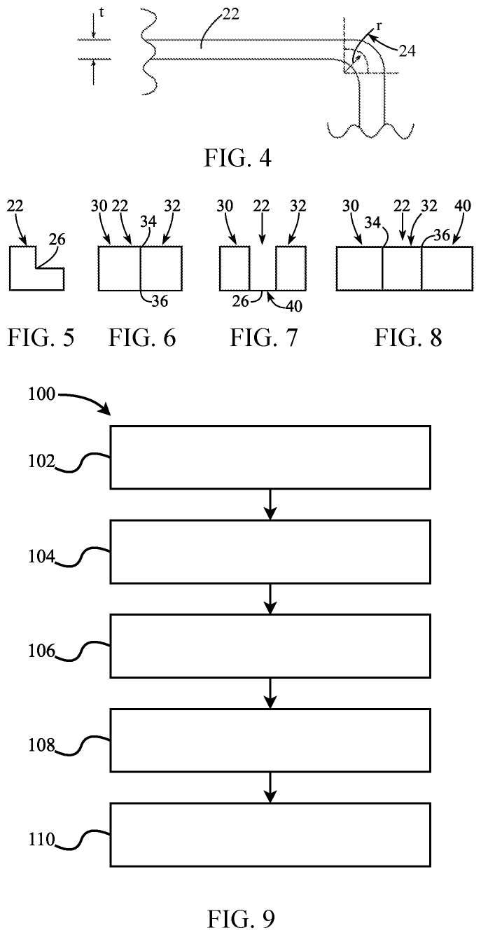

FIG. 4 illustrates a side cross section view of a corner 24 of the close section roll-formed component 22. Conventional corners in a roll-formed component commonly have a radius larger than 3t, where t is a wall thickness of the close section roll-formed component 22, and commonly a radius of 4t or more. The close section roll-formed component 22 disclosed herein has a corner radius r between 0.5t and 2t and a wall thickness t between 0.8 millimeters (mm) and 5.0 mm. It will be appreciated that the corner radius r can be less than 0.5t (e.g., 0.4t, 0.3t, and so forth) and greater than 2t (e.g., 2.25t, 2.5t, and so forth). It will be appreciated that the wall thickness t can be less than 0.8 mm (e.g., 0.7 mm, 0.6 mm, and so forth) or greater than 5.0 mm (e.g., 5.25 mm, 5.5 mm, and so forth).

Referring again to FIG. 3, the close section roll-formed component 22 has at least one weld seam 26 that joins multiple edges 28 of the close section roll-formed component 22. When welding conventional close section roll-formed components, a fusion zone forms in the weld seam that is surrounded by a soft heat affected zone (HAZ). A fracture can often form between the fusion zone and each soft HAZ. However, the weld seam 26 as disclosed herein does not have a soft HAZ proximate to the weld seam 26 subsequent to heating and quenching. This prevents fracturing and provides increased hardness within the weld seam 26 with a hardness, for example, of between 450 and 600 Vickers Pyramid Number (HV).

FIGS. 5 through 8 illustrate examples of the close section roll-formed component 22. FIG. 5 illustrates a cross section view of the close section roll-formed component 22 in a square tube configuration with one inverted corner. While the example illustrated in FIG. 5 shows the weld seam 26 positioned in the inverted corner, the weld seam 26 may be disposed at other locations of the close section roll-formed component 22.

FIG. 6 illustrates a cross section view of the close section roll-formed component 22 with two adjacent tubes 30, 32 in a square or rectangular configuration formed from one piece of sheet metal. The close section roll-formed component 22 in this example is shown with a first weld seam 34 and a second weld seam 36.

FIG. 7 illustrates a cross section view of the close section roll-formed component 22 with two adjacent tubes 30, 32 in a square or rectangular configuration connected by a planar section 38. In this example, the close section roll-formed component 22 includes one weld seam 26, which is disposed on the planar section 38. The close section roll-formed component 22 is roll-formed from one piece of sheet metal.

FIG. 8 illustrates a cross section view of the close section roll-formed component 22 having three adjacent tubes 30, 32, 40, and the tubes 30, 32, 40 are in a square or rectangular tube configuration. In this example, the close section roll-formed component 22 includes two weld seams 34, 36. It will be appreciated that the close section roll-formed component 22 and/or each tube 30, 32, 40 may include a variety of other configurations (e.g., a cylinder tube configuration, a triangular tube configuration, an oval configuration, a trapezoid configuration, and the like).

Additionally, the close section roll-formed component 22 has an increased ultimate tensile strength (UTS) and hardness across the weld seam 26. The UTS is a maximum stress that a material can withstand while being pulled or stretched before breaking. The close section roll-formed component 22 has an ultimate tensile strength between 1.5 gigapascals (GPa) and 2.1 GPa. The weld seam has a hardness between Vickers Pyramid Number (HV) 450 and 600.

The close section roll-formed component 22 has an increased yield strength. In an example, the close section roll-formed component 22 has a yield strength of between 1.0 gigapascals (GPa) and 1.8 GPa.

The close section roll-formed component 22 has a reduced surface oxidation. In an example, the close section roll-formed component 22 has a surface oxidation between 0.1 micrometers (μm) and 5.0 μm. Due to the presence of relatively thin surface oxidation resulting from the higher content of silicon and chromium, no coating is needed on the close section roll-formed component 22.

With reference to FIG. 9, a method 100 of forming a close section roll-formed component using coating free press-hardened steel is presented, in accordance with the present disclosure. Method 100 begins at block 102.

Block 102 depicts roll-forming as-annealed steel. Roll-forming the as-annealed steel enables a complex close section with tighter radii (e.g., 1t) and better dimensional tolerance because the as-annealed steel is soft and formable. Roll-forming the as-annealed steel can be performed using, for example, a rollformer. Method 100 then moves to block 104.

Block 104 depicts in-line welding the as-annealed and roll-formed steel to form a close section roll-formed component 22. In-line welding may include using a welder (e.g., a robotic welder) configured to provide a weld and weld seam to form and close the close section roll-formed component 22. Some types of in-line welding used may include high frequency welding, laser welding, rotation wheel electrode spot welding, and the like. Method 100 then moves to block 106.

Block 106 depicts heating the close section roll-formed component 22 to a temperature between 850° C. and 980° C. Heating may include using a heating unit configured to use induction heating, conduction heating, laser heating, a roller hearth, a chamber furnace, and the like.

For example, the heating unit may include at least one induction heating coil. The induction heating coil heats the close section roll-formed component 22 using electromagnetic induction through heat transfer passing through an inductor, which creates an electromagnetic field within the induction heating coil to heat the close section roll-formed component 22. The heat from the induction heating coil is generated inside the close section roll-formed component 22 instead of by an external heat source via heat conduction. In a specific example, the close section roll-formed component 22 is heated using induction heating to a temperature between about 850° C. and 980° C. It will be appreciated that the close section roll-formed component 22 may be heated to a temperature below 850° C. or above 980° C. In this context, the term “about” is known to those skilled in the art. Alternatively, the term “about” may be read to mean plus or minus 10° C.

Heating the close section roll-formed component 22 may also include using a laser-based heating device or a flame-based heating device. When a laser-based heating device is used, the device directs a laser onto the close section roll-formed component 22 for heating. When a flame-based heating device is used, a flame directed toward the close section roll-formed component 22 is used for heating. The method 100 then move to block 108.

Block 108 depicts soaking the close section roll-formed component 22. Soaking includes holding the heated close section roll-formed component 22 at a specific and constant temperature. Soaking the close section roll-formed component 22 allows for uniform temperature distribution throughout the close section roll-formed component 22 and ensures consistent transformation of microstructure within the close section roll-formed component 22. In an example, the close section roll-formed component 22 is soaked for between 1 and 1000 seconds. The method 100 then moves to block 110.

Block 110 depicts die quenching the close section roll-formed component 22 including rectification of the close section roll-formed component 22 to provide dimensional accuracy. Die quenching includes cooling the close section roll-formed component 22. Rapid cooling reduces the time during which undesired reactions may occur and through its eutectoid point during which austenite becomes unstable. Additionally, quenching prevents the formation of a cementite structure and dissolves carbon atoms in the ferrite lattice. Die quenching the close section roll-formed component 22 also induces martensite transformation making the close section roll-formed component 22 harder. Heating and quenching the close section roll-formed component 22 removes residual stress (which may cause distortion during assembly line welding) of roll-forming and can provide an ultimate tensile strength of up to 2 GPa. Typically, a conventional PHS requires a cooling rate greater than 30° C./second for hardening while the close section roll-formed component 22 only requires a cooling rate of 5° C./second or greater for hardening. Preferably, ambient air is used for quenching the close section roll-formed component 22. However, it will be appreciated that die quenching can be performed with other quenching media (e.g., forced air, forced water, and the like). Additionally, die and/or in-line rectification (or using another several sets of rollers) is used during die quenching to ensure dimensional accuracy in the close section roll-formed component 22. The method 100 then ends.

The close section roll-formed component 22 and method 100 of the present disclosure offers several advantages. For example, roll-forming the close section roll-formed component 22 in a soft as-annealed state facilitates ease in obtaining a complex close section. Using coating free super steel provides good hardenability for the heating and quenching process during which an ultimate tensile strength of up to 2 GPa is obtained, and residual stress of roll-forming is removed/reduced during heating and quenching. It is difficult to control the flatness and residual stress of martensitic steel. Thus, the annealed steel coil used herein has very low residual stress and distortion.

Additionally, using coating free super steel provides oxidation resistance for the heating and quenching process to avoid scale formation and decarburization (i.e., surface softening). The close section roll-formed component 22 has better edge quality and flatness in the as-annealed state, which is easier for close section welding. Plus, the close section roll-formed component 22 disclosed herein enables a corner radius of about 0.5t to 2t, and preferably 1t with a steel thickness between 0.8-3.0 millimeters. This tighter corner radius saves space, for example within a RESS, and provides larger mass saving potential. Moreover, the close section roll-formed component 22 has improved roll formed weld quality and no soft heat affected zone (HAZ) after heating and quenching.

What is claimed is:

1. A close section roll-formed component using coating free press-hardened steel, comprising:
the component having a microstructure including martensite and alloy carbide, and having a composition between 0.05 and 0.35 wt. % carbon, between 0.5 and 5.0 wt. % manganese, between 0.5 and 2.0 wt. % silicon, and 0.6 and 4.0 wt. % chromium;
a weld seam that joins at least two edges of the component; and
at least one corner of the component having a corner radius between 0.5t and 2t, wherein t is wall thickness, and wherein the wall thickness of the component is between 0.8 millimeters and 5.0 millimeters;
wherein the component has
an ultimate tensile strength between 1.5 gigapascals (GPa) and 2.1 GPa; and
a hardness across the weld seam between Vickers Pyramid Number (HV) 450 and 600.

2. The close section roll-formed component using coating free press-hardened steel of claim 1, wherein the component has a yield strength of between 1.0 gigapascals (GPa) and 1.8 GPa.

3. The close section roll-formed component using coating free press-hardened steel of claim 1, wherein the component has a hardness between Vickers Pyramid Number (HV) 450 and 600.

4. The close section roll-formed component using coating free press-hardened steel of claim 1, wherein the component has a surface oxidation between 0.1 micrometers (μm) and 5.0 μm.

5. The close section roll-formed component using coating free press-hardened steel of claim 1, wherein the component includes ferrite less than 5 vol. %.

6. The close section roll-formed component using coating free press-hardened steel of claim 1, wherein the component includes bainite and austenite less than 20 vol. %.

7. The close section roll-formed component using coating free press-hardened steel of claim 1, wherein the component includes a carbide fraction between 1.0 vol. % and 20 vol. % with a size between 10 nanometers (nm) and 500 nm.

8. The close section roll-formed component using coating free press-hardened steel of claim 1, wherein the component includes a chromium content of carbides between 5 wt. % and 60 wt. %.

9. The close section roll-formed component using coating free press-hardened steel of claim 1, wherein the component includes niobium less than 0.05 wt. %.

10. The close section roll-formed component using coating free press-hardened steel of claim 1, wherein the component includes yttrium less than 0.3 wt. %.

11. The close section roll-formed component using coating free press-hardened steel of claim 1, wherein the component includes cerium less than 0.3 wt. %.

12. The close section roll-formed component using coating free press-hardened steel of claim 1, wherein the corner radius is 1t with t being wall thickness.

13. A vehicular structural component, comprising:
a close section roll-formed component using coating free press-hardened steel, wherein the component has a microstructure including martensite, alloy carbide, between 0.05 and 0.35 wt. % carbon, between 0.5 and 5.0 wt. % manganese, between 0.5 and 2.0 wt. % silicon, and 0.6 and 4.0 wt. % chromium, and wherein the component includes:
a weld seam that joins at least two edges of the component;
at least one corner of the component having a corner radius between 0.5t and 2t, wherein t is wall thickness, and wherein the wall thickness of the component is between 0.8 millimeters and 5.0 millimeters;
a yield strength of between 1.0 gigapascals (GPa) and 1.8 GPa;
an ultimate tensile strength between 1.5 GPa and 2.1 GPa;
a hardness between Vickers Pyramid Number (HV) 450 and 600;
a surface oxidation between 0.1 micrometers (μm) and 5.0 μm; and
a hardness across the weld seam between 450 HV and 600 HV.

14. A method of forming a close section roll-formed component using coating free press-hardened steel, comprising:
roll-forming as-annealed steel, wherein the as-annealed steel has a microstructure including martensite, alloy carbide, between 0.05 and 0.35 wt. % carbon, between 0.5 and 5.0 wt. % manganese, between 0.5 and 2.0 wt. % silicon, and 0.6 and 4.0 wt. % chromium;
in-line welding the steel to form a close section roll-formed component, wherein a hardness across a resulting weld seam is between 450 Vickers Pyramid Number (HV) and 600 HV after heat treatment, and wherein at least one corner of the component has a corner radius between 0.5t and 2t, wherein t is wall thickness, and wherein the wall thickness of the component is between 0.8 millimeters and 5.0 millimeters;
heating the close section roll-formed component to a temperature between 850° C. and 980° C.;
soaking the close section roll-formed component for between 1 second and 1000 seconds; and
die quenching the close section roll-formed component including rectification of the component to provide dimensional accuracy.

15. The method of claim 14, wherein the component has a yield strength of between 1.0 gigapascals (GPa) and 1.8 GPa.

16. The method of claim 14, wherein the component has a hardness between Vickers Pyramid Number (HV) 450 and 600.

17. The method of claim 14, wherein the component has a surface oxidation between 0.1 micrometers (μm) and 5.0 μm.

18. The method of claim 14, wherein the corner radius is 1t.

19. The method of claim 14, wherein the component includes ferrite less than 5 vol. %.

20. The method of claim 14, wherein the component includes bainite and austenite less than 20 vol. %.
